(19) United States
(12) Patent Application Publication
(10) Pub. No.: US 2010/0185587 A1
(43) Pub. Date: Jul. 22, 2010

(54) DATA MOVEMENT WITH REDUCED SERVICE OUTAGE

(75) Inventor: Daniel E. Lovinger, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/350,967

(22) Filed: Jan. 9, 2009

(51) Int. Cl. G06F 17/30

(52) U.S. Cl. 707/660; 707/E17.005; 707/E17.01

(57) ABSTRACT

A data movement system is described herein that allows an administrator to cause data to be moved from one server to another with little or no service outage and in an amount of time that is proportional to the overall size of the data being moved rather than the way the data is organized. The system uses virtual hard drive technology to encapsulate the file system of a share within a single file of a host file system to allow snapshots taken at the volume level to avoid data unrelated to the share and to allow block level copy operations. The system also uses a motion process that includes steadily converging snapshots to copy data without interrupting access to the source location. The system provides tombstone notifications to clients that attempt to access the data at the source location after the data has moved.

### BACKGROUND

Distributed file systems, such as Microsoft Windows Server Message Block (SMB)/Distributed File System Namespaces (DFS/DFSN), provide a virtual namespace that spans a number of underlying shared file systems. SMB operates as an application-level network protocol to provide shared access to files, printers, serial ports, and miscellaneous communications between nodes on a network. DFS provides a level of indirection between the share and/or folder names used to access data and the server on which the data is physically stored. Individual folders in a DFS namespace may reside on different servers and may change servers over time. For example, DFS may present a single disk drive to a client where multiple different servers actually host folders of the drive. DFS also simplifies the process of moving data from one file server to another. Because users do not need to know the name of each physical server or shared folder that contains data, administrators can physically move data to another server without needing to reconfigure applications and shortcuts and without needing to reeducate users about where they can find their data. For example, a share “\\server\applications” may initially reside on a server named server1, and at a different location (e.g., “\\server1\folder\apps”). Later, an administrator may move the share to a server named server2. Users using the DFS namespace (\\server\applications) will still find the data regardless of where it resides. This minimizes the impact of server consolidation on users. It also allows administrators to deploy additional file servers and present the folders on those new servers as new folders within an existing namespace.

DFS also provides increased availability and load sharing. In the event of a server failure, DFS refers client computers to the next available server, so users can continue to access shared folders without interruption. To prepare for this scenario, an administrator ensures that the data is copied to two or more servers. DFS provides a degree of load sharing by mapping a given logical name to shared folders on multiple file servers. For example, suppose that \\Company\StockInfo is a heavily used shared folder. Administrators can use DFS to associate this location with multiple shared folders on different servers, even if the servers are located in different sites. Each server contains the same data, and users are not aware that different servers physically store and provide access to the data.

One administrative problem with using DFS is moving data from one server to another. An administrator may want to move data from one server to another for a variety of reasons. For example, the administrator may want to replace the original server with newer hardware, move a company's data from one datacenter to another, and so on. An administrator can do this today using basic tools, such as Robocopy (which is provided in the Microsoft Windows Resource Kit). However, using these tools typically requires a service outage during which clients are unable to access the server. This outage can carry a high cost. During the outage, service may be unavailable or, worse, at risk of losing data, depending on the methods used. Based on the scale of the share and available bandwidth, the outage may extend into hours. This places a limit on when and how often administrators can use motion as an administrative tool. Some vendors attempt to solve this problem by placing an expensive server appliance in between clients and the data server. The server appliance keeps a copy of all data sent to and received from the data server. However, such products are expensive and create a bottleneck for performance that is not acceptable for many organizations.

Another problem is the difficulty in predicting how long a data movement will take. The time involved with a data movement is related to the complexity of the data stored on the data server, including the number of files, folders, and level of nesting within the file system. Tools such as those mentioned above typically enumerate each file on the data server and copy files one by one to the new location. For data servers with complex directory structures, this only increases the time involved with moving the data.

### SUMMARY

A data movement system is described herein that allows an administrator to cause data to be moved from one server to another with little or no service outage and in an amount of time that is proportional to the overall size of the data being moved rather than the way the data is organized. The system uses virtual hard drive technology to encapsulate the file system of a share within a single file of a host file system to allow snapshots taken at the volume level to avoid data unrelated to the share and to allow block level copy operations. The system also uses a motion process that includes steadily converging snapshots to copy data from a source location to a target location without interrupting access to the source location. The data movement system manages the state of the source and target servers to ensure that requests are handled correctly during and after a data movement operation, including providing tombstone notifications to clients that attempt to access the data at the source location after the data has been moved. Thus, the data movement system allows data movement to be used as a more effective tool by system administrators, because administrators no longer need to worry about protracted copy operations or system outages resulting from data movement between servers.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the data movement system, in one embodiment.

FIG. 2 is a block diagram that illustrates a volume bitmap at various stages of data movement, in one embodiment.

FIG. 3 is a flow diagram that illustrates the processing of the data movement component to copy data from a source location to a target location using consecutive snapshots, in one embodiment.

FIG. 4 is a flow diagram that illustrates the state transitions of the source share performed by the state management component, in one embodiment.

FIG. 5 is a flow diagram that illustrates the processing of the state management component at the target location, in one embodiment.

### DETAILED DESCRIPTION

A data movement system is described herein that allows an administrator to cause data to be moved from one server to another with little or no service outage and in an amount of time that is proportional to the overall size of the data being moved rather than the way the data is organized (e.g., the file and folder structure). The system leverages three facilities to overcome the challenges of previous systems. First, the system uses virtual hard drive technology to encapsulate the file system of a share within a single file of a host file system. Second, the system uses a motion process that includes steadily converging snapshots to copy data from a source location to a target location without interrupting access to the source location. Finally, the data movement system manages the state of the source and target servers to ensure that requests are handled correctly during and after a data movement operation. Each of these facilities is described in further detail herein. Using these facilities, the data movement system allows data movement to be used as a more effective tool by system administrators, because administrators no longer need to worry about protracted copy operations or system outages resulting from data movement between servers.

### System Overview

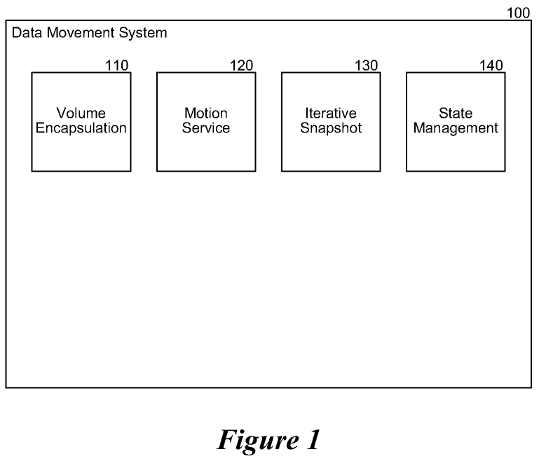

FIG. 1 is a block diagram that illustrates components of the data movement system, in one embodiment. The data movement system 100 includes a volume encapsulation component 110, a motion service 120, an iterative snapshot component 130, and a state management component 140. Each of these components is described in further detail herein.

The volume encapsulation component 110 encapsulates the data of a file share in a virtual volume stored within the file system of a host volume. Volume encapsulation allows the data movement system 100 to perform snapshots and other volume-based operations on the data of the share without other data stored on the host volume affecting the operations. In addition, volume encapsulation converts operations that copy the share data into block-level operations instead of file-level operations. These and other details of the volume encapsulation component 110 are described in detail herein.

The motion service 120 is the base provider for storage motion. Building on the VHD model described herein with block copy semantics and local snapshot support, it builds an iterative model for snapshot transfer. This allows background transfer with repeated snapshots to converge the transfer to the source image. The motion service 120 invokes the other components described herein to manage various aspects of movement of a share from a source location to a target location, including copying the encapsulated share data, blocking access to the data if needed, and managing state transitions so that data access requests are reliably transitioned from the source location to the target location. The motion service 120 may run on a server hosting the source location, a server hosting the target location, or on a different server entirely that manages the DFS namespace or other distributed storage technology.

The iterative snapshot component 130 moves data from the source location to the target location without interrupting access to the source location. The component 130 operates by repeating the process of taking a snapshot of the source location and copying the data changed since the previous snapshot. With each successive snapshot, there may be less data to copy so long as copying data is sufficiently faster than the rate of writing new data or modifying data at the source location. This process is described in further detail herein.

The state management component 140 manages access to the source and target locations during and following data movement, including providing tombstone notifications to clients. A tombstone is a placeholder notification that the component 140 provides to a client that tries to access data at a location from which the system has moved data. The tombstone may provide information about the new location of the data so that the client can request the data from the new location. Tombstones generally have an expiration after which the state management component 140 removes the notification.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

### Volume Encapsulation

One facility used by the data movement system in some embodiments is the encapsulation of a share within a virtual hard drive. Virtualization solutions, such as Microsoft Virtual PC, allow a user to run multiple virtual machines on a host computer. For example, a user running a Microsoft Windows Vista host could use Microsoft Virtual PC to run a Microsoft Windows XP virtual machine, a Linux virtual machine, and so forth. A virtual machine stores its data just like the host system does, using a file system driver and operating system hardware method calls. However, a virtual machine accesses virtual hardware rather than physical hardware, since the virtual machine shares the physical hardware of the host with the host operating system and with other virtual machines. Thus, virtual machine technology typically encapsulates the hard drive of each virtual machine into a single file within the host operating system. For Microsoft Virtual PC, these files have a VHD extension (i.e., Virtual Hard Drive). Inside, these files contain all of the file system data structures and file/folder data that would normally be found on a physical hard drive. However, from the perspective of the host operating system, the entire hard drive is a single file.

Typical snapshot algorithms operate at the volume level. When an administrator activates snapshot support (e.g., within the operating system or an application), a snapshot application periodically creates a bitmap that specifies the state of each block of data on the volume. A snapshot operation does not typically cause any data to be copied, because the data is still available in its original location. As the data on a volume changes (e.g., in response to write requests from applications), the system copies the original data at a changed location to a location associated with the snapshot. When the system takes a later snapshot, the system creates a new differential bitmap that specifies the locations that have changed since the previous snapshot. If an application wants to copy the data as it was at the time of the original snapshot, the bitmap provides information for accessing the data, either at its original location (if it has not changed since the snapshot) or at the copied location (if it has changed since the snapshot). Thus, snapshots provide a mechanism for making a copy of a volume as that volume was at the time of the snapshot.

However, a downside of snapshots is that they grow with the number of changes made to the volume (based on the copied data described herein). On a volume that is rapidly changing, snapshots can become large very quickly. Data associated with a DFS share may only comprise a part of a large volume of a server. Because snapshots typically operate at the volume level, and because snapshots grow as data on the volume changes, snapshots can be inefficient for moving shares that only relate to a part of a volume. The continued operations of the other services accessing the file system (e.g., other shares, databases, and system files) contribute overhead by inflating the space used to hold the stable file system image.

To overcome this problem, the data movement system in some embodiments combines the two facilities described above to more efficiently move data. First, the system encapsulates each share in a virtual hard drive that is stored as one or more files on a host volume. This allows the system to use snapshots that affect only the data of the share by taking a snapshot of the virtual hard drive. The virtual hard drive is a volume in its own right, albeit encapsulated within the host system's file structure. A snapshot of the virtual hard drive changes only when the virtual hard drive data is modified, and is unaffected by other modifications to the host volume.

Second, when moving data the data movement system copies the virtual hard drive from one host volume to another. Because the virtual hard drive appears as a file on the host volume, the host can copy the virtual hard drive without being affected by the complexity of the virtual hard drive's file system structure. The data on the virtual hard drive may be stored in any number of folders or files, but the host system still views the data as a single file (or a small number of files as some virtualization technologies separate information about the virtual volume from data on the virtual volume). In other words, the data movement system converts the granularity of data movement from the file level to the block level, while still maintaining file-level structures.

In some embodiments, the data movement system leverages operating system support for mounting and performing storage operations on virtual volumes. For example, Microsoft Windows 7 provides support for VHD files as a type of local disk object that can be mounted and accessed just like a physical disk. Administrators can perform snapshots and other storage operations to the virtual hard drive in the same way as physical hard drives. When creating new shares, the operating system may support specifying a virtual share that is backed by a virtual hard drive rather than a physical drive and path that are specified for traditional shares.

### Iterative Snapshots

The second facility used by the data movement system in some embodiments is the use of multiple snapshots to copy data from a source location to a target location without interrupting access to the source location. The data movement system takes a first snapshot of the source location at time T0, and copies data based on the snapshot to the target location. Clients continue to access the source location, and may modify the data stored there. When the system is finished copying the data from the first snapshot, the system takes a second snapshot at time T1. The system compares the first and second snapshots to create a differential bitmap that indicates data that has changed between time T0 and T1. Then, the system copies any changed data to the target location. This process repeats until either no more data has changed or until one or more exit conditions are met. For example, the system may stop the process of taking snapshots if the amount of data to copy is not becoming smaller. This can happen, for example, if the level of client modifications to the source location remains high.

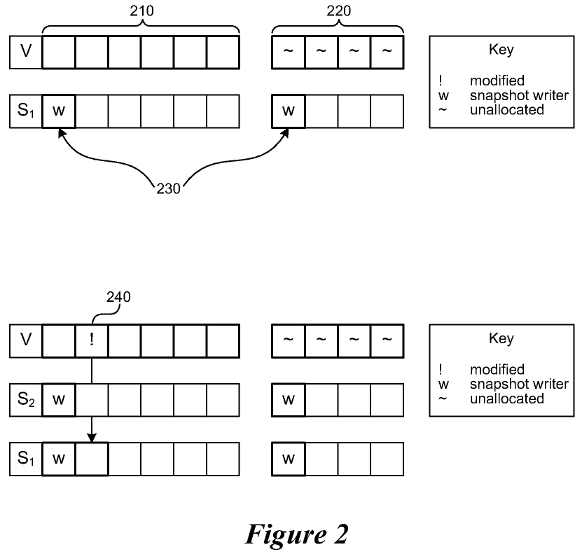

FIG. 2 is a block diagram that illustrates a volume bitmap at various stages of data movement, in one embodiment. When an administrator instructs the data movement system to block copy a share encapsulated in a virtual hard drive, the system takes an initial snapshot of the stored in the virtual hard drive. For example, consider a VHD and its snapshot S1 at the time an initial block copy of S1 to a target location. Let α( ) represent a function for retrieving a bitmap of the file system's allocated clusters (e.g., FSCTL_GET_VOLUME_BITMAP using Microsoft Windows), and let Δ( ) represent a function for querying the snapshot's allocated blocks. Assume logical operations that perform bitwise logical operations on these bitmaps to an equal granularity (e.g., blocks).

As shown in FIG. 2, the volume initially has six blocks allocated 210 and four blocks unallocated 220. At S1's creation, a snapshot writer modified two blocks 230, one that was unallocated in the source. Aside from the base overhead of storing the original volume data, the snapshot has added only these two blocks newly written blocks. In the initial bulk transfer the motion service transfers Δ(S1)|α(V), the original data plus the two changed blocks. The volume bitmap may also allow the service to avoid transferring unallocated blocks.

During the initial transfer, continued access to the volume by clients modifies one more block 240. After the initial snapshot transfer, the motion service takes a second snapshot S2. In the snapshot model, S2 inserts between S1 and V (because the newest snapshot is closer in makeup to the volume than older snapshots). S2 stabilizes the bitmaps in S1. Note that if Δ(S1) is equivalent to its earlier state, transfer is complete. The blocks to transfer are now Δ(S2)|Δ(S1), via S2.

A subsequent snapshot S3 could be taken, iterating until the bitmaps reach a threshold of equivalence—e.g., countofbits(Δ(Sₙ₊₁) XOR Δ(Sₙ))→0 (where countofbits is a function that counts the non-zero bits in the result). The system may also use an iteration cap in combination with the threshold of equivalence to handle shares that continue to have higher levels of write traffic.

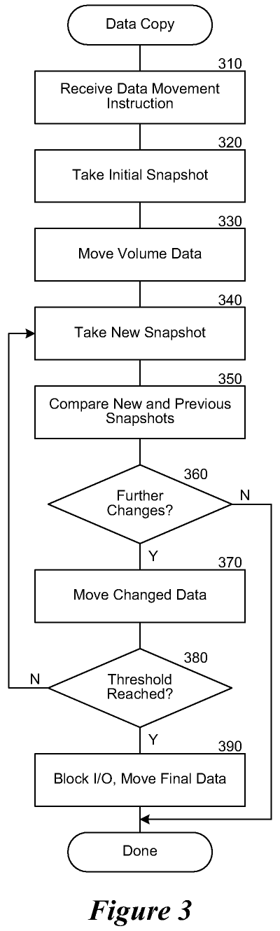

FIG. 3 is a flow diagram that illustrates the processing of the data movement component to copy data from a source location to a target location using consecutive snapshots to reduce unavailability of the data during the copy, in one embodiment. In block 310, the component receives a data movement instruction that specifies a source and target location. For example, an administrator may use a disk administration tool that provides a user interface for the data movement system to select volumes and request data movement between selected volumes. Control continues to block 320, where the data movement component takes an initial snapshot of the source location. For example, the component may use an operating system-provided snapshot function to initiate a snapshot of a share backed by a virtual hard drive. The initial snapshot provides a bitmap of a status of each block of data of the source location. Next control continues to block 330, where the component moves the original volume data and any changed data indicated by the first snapshot. During the copy, clients can continue to access the data at the source location.

Control continues to block 340, where the component takes another snapshot. Then control continues to block 350, where the component compares the new snapshot with the previous snapshot to determine data that clients have modified since the previous snapshot. For example, the component may compare a volume bitmap taken at the time of the previous snapshot with a new volume bitmap associated with the new snapshot. Control continues at decision block 360. In decision block 360, if the comparison indicates no changes since the previous snapshot, then the copy operation is complete and these steps conclude, else control continues to block 370. In block 370, the component copies modified data indicated by the new snapshot, then continues to block 380.

In decision block 380, if an iteration threshold has been reached, then the component continues at block 390 and completes the data movement operation, else the component loops to block 340 to take a new snapshot. In block 390, the component blocks access to the source location, copies any remaining data, and then completes the data movement operation. After block 390, these steps conclude.

In some embodiments, the data movement system exits the snapshot process based on the number of snapshots taken. For example, the system may impose an iteration threshold to provide an upper bound on the duration of the data movement operation and ensure that the operation does not loop endlessly because of ongoing access to the volume. The iteration threshold may be predefined or may be determined heuristically based on, for example, the size of the data, historical access patterns, and so forth.

In some embodiments, the data movement system exits the snapshot process based on a comparison of the amount of data copied in subsequent snapshots. Typically, the initial copy operation will be very large while subsequent snapshot-based copies become smaller and smaller in size. Eventually, the size of the changed data indicated by the snapshot may be small enough that further iterations are less efficient than a brief pause in access to the volume while the system copies the remaining data.

When the data movement system exits the snapshot process before all data changes have been copied, the system can complete the transfer of data by blocking client access to the source location for a brief time and copying the remaining data. Note that the amount of time that clients cannot access the source location is much smaller than a typical service outage when copying data in previous systems, because the data movement system only has to copy the data changed since the last snapshot-based copy. In addition, clients may be able to access data that has already been copied to the target location so that only the small amount of final data remaining to be copied is inaccessible.

### State/Tombstone Management

During a motion operation, the data movement system manages the source and target shares through a sequence of states. For example, these states can correspond to a provider model, allowing the system support non-SMB shares, such as the Network File System (NFS). When the motion operation starts, clients can continue to access data at the source location. When data movement is complete, the data movement system provides state management that informs clients of the target location and provides for a transition period during which the system forwards requests received at the source location to the target location.

Tombstones are a special share type that persist a notification to clients that a server no longer hosts a given share. Tombstones are not backed by physical storage. Rather, at the time a share has transitioned to being a tombstone, the system may be already removing data associated with the share. The system manages the creation and lifespan of tombstones. Creation of tombstones initiates the transfer of online state from the source to target shares, managed by the share provider. To manage this process, the system pauses I/O operations at the source. The system also brings the target share online in a paused state in order to allow consistent state migration.

In some embodiments, tombstone creation and management functions much like the flush-and-hold semantics of snapshot creation in local file systems, with the difference that when the share comes online again, it is located at the target location. Following the iterative snapshot transfer process described above, the system takes the source and target shares through the state model described below.

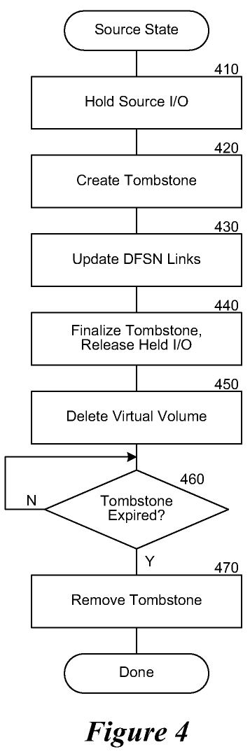

FIG. 4 is a flow diagram that illustrates the state transitions of the source share performed by the state management component, in one embodiment. Starting in block 410, the component holds I/O on the source share to set up for the final snapshot and data transfer described herein. For example, if the iterative snapshot process did not converge because of continued client access to the source share, this step will allow the system to pause client requests and copy the last remaining blocks of data to the target share. Continuing in block 420, the component creates a tombstone on the source share so that subsequent requests to access data at the source location will receive a notification of the new location of the data. For example, the system may create a tombstone that includes a path to the target location.

Continuing in block 430, the component modifies the DFSN to cause future requests to the distributed namespace to locate the moved data at the target location rather than the source location. For example, if a DFS share is distributed across two servers (e.g., \\apps\share maps to \\server1\share and \\server2\share), and one of servers is swapped for a new server, then the DFS links are updated to point to the new server (e.g., \\apps\share maps to \\server1\share and \\server3\share, where data has been moved from server2 to server3). Continuing in block 440, the component finalizes the tombstone and releases held I/O on the source server. Any requests that the system held will see the tombstone and redirect to the target location. Continuing in block 450, the component deletes the virtual hard drive at the source location that encapsulated the share data.

Continuing in decision block 460, if a tombstone time-to-live (TTL) has been reached, then the component continues at block 470, else the component loops to block 460 to continue waiting for the TTL to be reached. The tombstone TTL may be based on the SMB TTL given out when a client first accesses a share. The TTL is generally chosen to be long enough that clients accessing the share after the tombstone expires will get updated information about the share location through DFSN. In block 470, the component deletes the tombstone. In this way, the source share provides a notification to any lingering requests for a certain period specified by the TTL, but the source server can eventually clean up state and other resources associated with the source share. After block 470, these steps conclude.

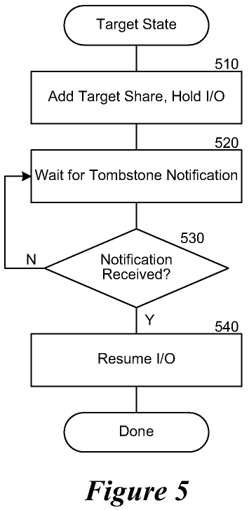

FIG. 5 is a flow diagram that illustrates the processing of the state management component at the target location, in one embodiment. The component performs these steps in concert with those of the previous figure to manage an orderly transition from accessing the data at the source location to accessing the data at the target location. Starting in block 510, the component adds the target share and holds I/O to bring the target share online when the transfer is complete. Access is initially held to ensure an orderly transition between the two shares. The component adds the target share by specifying the copied VHD or other file that encapsulates the transferred data.

Continuing in block 520, the component waits for a notification that the source share has successfully created a tombstone. The notification may include any dynamic state information from the source share that will be useful to the operation of the target share. Continuing in decision block 530, if the notification is received, then the component continues at block 540, else the component loops to block 520 to continue waiting. In block 540, the component resumes I/O at the target location, and starts handling requests to access the data. Following block 540, these steps conclude.

With respect to FIGS. 4 and 5, if any part of the data movement operation fails, then the system abandons the data movement and clients can continue to access the data at the source location. The system may retry the data movement or inform an administrator so that any problems blocking the data movement can be addressed before the operation is retried.

From the foregoing, it will be appreciated that specific embodiments of the system have been described herein for purposes of illustration, but that various modifications may be made without deviating from the spirit and scope of the invention. For example, although DFS shares have been described as examples, other server and file system protocols can be used with the techniques described herein with similar results. As another example, although VHD files have been described, other types of volume encapsulation techniques can be used with the system. Accordingly, the invention is not limited except as by the appended claims.

I/we claim:

1. A computer-implemented method for copying data from a source location to a target location that reduces unavailability of the data during the copy, the method comprising:
a) receiving a data movement instruction that specifies a source location and a target location, wherein the source location is a share backed by a virtual hard drive stored on a host volume;
b) taking an initial snapshot of the source location, wherein the initial snapshot provides a bitmap of a status of each block of data of the source location, and wherein taking an initial snapshot comprises taking a snapshot of the virtual hard drive;
c) moving each block of data from the source location indicated by the first snapshot to the target location;
d) taking a second snapshot, wherein the second snapshot provides a bitmap of an updated status of each block of data of the source location;
e) comparing the second snapshot with a previous snapshot to determine data that has been modified since the initial snapshot;
f) if the second snapshot indicates modified data, moving the modified data from the source location to the target location; and
g) repeating steps (d) through (f) until either the second snapshot indicates that no data has changed or until an iteration threshold is reached,
wherein the preceding steps are performed by at least one processor.

2. The method of claim 1 wherein receiving a data movement instruction comprises receiving the instruction from an administrator via a disk administration tool that provides a user interface to a data movement system.

3. The method of claim 1 wherein taking an initial snapshot comprises invoking an operating system-provided snapshot function.

4. The method of claim 1 wherein backing the share with the virtual hard drive yields a duration for moving the data that is based on a size of the data and not the file system structure of the data.

5. The method of claim 1 wherein the snapshot includes changes to the virtual hard drive without including changes to the host volume that are not related to the virtual hard drive.

6. The method of claim 1 wherein clients can continue to access the data at the source location during the data movement.

7. The method of claim 1 further comprising, when the iteration threshold is reached, blocking access to the source location and copying any remaining data, wherein a duration of blocking access to the source location to copy remaining data is shorter than a duration of blocking access to copy all of the data at the source location to the target location.

8. The method of claim 1 wherein the iteration threshold is based on an amount of remaining data to be copied.

9. The method of claim 1 wherein the iteration threshold is based on a count of iterations completed.

10. The method of claim 1 wherein the iteration threshold is based on a length of time consumed by the method.

11. A computer system for moving shared data from one location to another, the system comprising:
a processor and memory configured to execute software instructions;
a volume encapsulation component configured to encapsulate data of a file share in a virtual volume stored within a file system of a host volume;
a motion service configured to manage movement of a share from a source location to a target location, including copying the encapsulated share data, blocking access to the data when needed, and managing state transitions so that data access requests are reliably transitioned from the source location to the target location;
an iterative snapshot component configured to move data from the source location to the target location without interrupting access to the source location; and
a state management component configured to manage access to the source and target locations during and following data movement, including providing tombstone notifications to clients.

12. The system of claim 11 wherein the volume encapsulation component allows the system to perform snapshots on the data of the file share without being impacted by other data stored on the host volume.

13. The system of claim 11 wherein the volume encapsulation component allows block-level copying of the data of the file share.

14. The system of claim 11 wherein the motion service invokes the iterative snapshot component to copy data and the state management component to manage state transitions.

15. The system of claim 11 wherein the motion service runs on a server hosting the source location.

16. The system of claim 11 wherein the iterative snapshot component is further configured to repeat a process of taking a snapshot of the source location and copying the data changed since a previous snapshot until there is no modified data since the previous snapshot.

17. The system of claim 11 wherein the tombstone notification provided by the state management component is a placeholder notification that is provided to a client that tries to access data at a location from which data has been moved, and wherein the tombstone notification provides information about the new location of the data.

18. A computer-readable storage medium comprising instructions for controlling a computer system to manage the state of a source location from which data is to be moved, wherein the instructions, when executed, cause a processor to perform actions comprising:
performing a set of iterative snapshots to transfer data from the source location to a target location, wherein the source location is a share associated with a virtual hard drive and transferring data comprises copying the virtual hard drive;
holding access requests received at the source location to set up for a final snapshot and data transfer from the source location to the target location;
creating a tombstone related to the source location so that currently held and subsequent requests to access data at the source location will receive a notification of the target location where the data can be found;
modifying one or more links to the source location to cause future requests to a distributed namespace to locate the moved data at the target location rather than the source location; and
releasing held access requests received at the source location.

19. The computer-readable medium of claim 18 further comprising, after releasing held access requests, deleting the data from the source location.

20. The computer-readable medium of claim 18 further comprising, when a tombstone time-to-live has been reached deleting the tombstone related to the source location.
